(19) United States
(12) Patent Application Publication
(10) Pub. No.: US 2026/0359067 A1
(43) Pub. Date: Nov. 12, 2026

(54) DYNAMIC PIN CONFIGURATIONS FOR BOOTING A DEVICE

(71) Applicant: TEXAS INSTRUMENTS INCORPORATED, Dallas, TX (US)

(72) Inventors: Siva Kothamasu, Frisco, TX (US); Venkateswar Kowkutla, Allen, TX (US); Anthony Seely, Wylie, TX (US); Benoit Parrot, Mckinney, TX (US); Venkateswara Rao Mandela, Bangalore (IN); John Apostol, Richardson, TX (US)

(21) Appl. No.: 19/403,485

(22) Filed: Nov. 28, 2025

Related U.S. Application Data
(60) Provisional application No. 63/789,505, filed on Apr. 16, 2025.

(51) Int. Cl. G06F 9/4401

(52) U.S. Cl. CPC G06F 9/4411

(57) ABSTRACT

The present disclosure relates to system initialization. In one embodiment, a technique for determining a pin configuration is provided. The technique first includes receiving a signal on a set of pins and determining to boot a device per a first or second pin configuration based on a first portion of the signal. In response to determining to boot the device per the first configuration, the technique includes generating a boot value using the first and second portions of the signal. Alternatively, in response to determining to boot the device per the second configuration, the technique includes generating the boot value using the first, second, and third portions of the signal. Next, the technique includes storing the boot value in a register. Once stored, the technique includes, reading the boot value from the register, identifying boot sources based on the boot value, and booting the device from the boot sources.

### CROSS-REFERENCE TO RELATED APPLICATION

This application is related to, and claims the benefit of priority to, United States Provisional Patent Application No. 63/789,505, filed on Apr. 16^{th}, 2025, and entitled “VARIABLE LENGTH BOOT MODE SELECTION”, which Application is hereby incorporated herein by reference in its entirety

### TECHNICAL FIELD

Aspects of the disclosure are related to system initialization, and in particular, to techniques for determining a boot mode.

### BACKGROUND

Various devices exist in which read-only memory (ROM) is the only supported form of nonvolatile memory. For example, such devices include microcontroller units (MCUs), application-specific integrated circuits (ASICs), and system-on-chips (SoCs) that rely exclusively on ROM. Accordingly, the ROM of these devices stores a bootloader to enable application-specific program code to be loaded to the device’s volatile memory during system startup.

### SUMMARY

Disclosed herein is technology, including systems, methods, and devices for generating a boot value for initializing a system in accordance with a determined pin configuration.

In one example embodiment, a device comprising control circuitry, processing circuitry, and a mode register coupled to the control circuitry and the processing circuitry is provided. In an implementation, the control circuitry is configured to receive a configuration signal on a set of pins and determine whether to boot the device according to a first pin configuration or a second pin configuration based on a first portion of the configuration signal received on a first subset of the pins. If the control circuitry determines to boot the device according to the first pin configuration, then the control circuitry is configured to generate a boot value using the first portion of the configuration signal and a second portion of the configuration signal received on a second subset of the pins. Once generated, the control circuitry is configured to store the boot value in the mode register. Alternatively, if the control circuitry determines to boot the device according to the second pin configuration, then the control circuitry is configured to generate the boot value using the first portion of the configuration signal, the second portion of the configuration signal, and a third portion of the configuration signal received on a third subset of the pins. Once generated, the control circuitry is configured to store the boot value in the mode register. In either case, the processing circuitry is configured to read the boot value from the mode register and identify one or more boot sources based on the boot value. Once identified, the processing circuitry is configured to boot the device from the one or more boot sources.

In a second example embodiment, control circuitry including interface circuitry and logic circuitry is provided. In an implementation, the interface circuitry is configured to receive a configuration signal on a set of pins and the logic circuitry is configured to determine, based on a first portion of the configuration signal received on a first subset of the pins, whether to boot a device according to a first pin configuration or a second pin configuration. If the logic circuitry determines to boot the device according to the first pin configuration, then the logic circuitry is configured to generate a boot value using the first portion of the configuration signal and a second portion of the configuration signal received on a second subset of the pins. Once generated, the logic circuitry is configured to store the boot value in a mode register. Alternatively, if the logic circuitry determines to boot the device according to the second pin configuration, then the logic circuitry is configured to generate the boot value using the first portion of the configuration signal, the second portion of the configuration signal, and a third portion of the configuration signal received on a third subset of the pins. Once generated, the logic circuitry is configured to store the boot value in the mode register.

In a third example embodiment, a method for booting up a device is provided. In an implementation, the method first includes, by interface circuitry, receiving a configuration signal on a set of pins. Next, the method includes, by logic circuitry, determining whether to boot a device according to a first pin configuration or a second pin configuration based on a first portion of the configuration signal received on a first subset of the pins. If the logic circuitry determines to boot the device according to the first pin configuration, then the method includes, by the logic circuitry, generating a boot value using the first portion of the configuration signal and a second portion of the configuration signal received on a second subset of the pins. Once generated, the method includes, by the logic circuitry, storing the boot value in a mode register. Alternatively, if the logic circuitry determines to boot the device according to the second pin configuration, then the method includes, by the logic circuitry, generating the boot value using the first portion of the configuration signal, the second portion of the configuration signal, and a third portion of the configuration signal received on a third subset of the pins. Once generated, the method includes, by the logic circuitry, storing the boot value in the mode register. In either case, the method then includes, by processing circuitry, reading the boot value from the mode register and identifying one or more boot sources based on the boot value. Once identified, the method includes, by the processing circuitry, booting the device from the one or more boot sources.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a boot method in an implementation.

FIG. 3 illustrates a sequence diagram in an implementation.

FIG. 4 illustrates a boot mode table in an implementation.

FIGS. 5A-5D illustrate a control unit in an implementation.

FIG. 6 illustrates another boot mode table in an implementation.

FIGS. 7A-7D illustrate devices in various implementations.

### DETAILED DESCRIPTION

Systems, methods, and devices are disclosed herein that provide a technique for initializing a system. The disclosed technique(s) may be implemented in the context of hardware, software, firmware, or a combination thereof to provide a method that enables processing circuitry to boot up a device in accordance with either a limited-pin configuration or a full-pin configuration. Advantageously, the proposed technology provides a variety of boot options which reduce the overall system cost, power consumption, and area.

To initialize a device, the processing circuitry of the device executes a bootloader. The bootloader refers to program code that is stored in the read-only memory (ROM) of the device. When executed, the bootloader causes the processing circuitry to load application-specific code from an off-chip interface to the volatile memory of the device. More specifically, the bootloader causes the processing circuitry to determine a boot mode and a corresponding boot value for performing the initialization. The boot mode is an indicator that specifies one or more boot sources from which the processing circuitry may load the application-specific program code, while the boot value is a binary value that identifies the selected boot mode. For example, a boot mode defines a primary boot source and a secondary boot source for initializing the device, while the boot value identifies the primary and secondary boot sources of the selected boot mode. The primary boot source is the off-chip interface from which the processing circuitry first attempts to load the program code from, while the secondary boot source is an alternative off-chip interface for when the primary source fails.

In existing systems, the boot value is supplied to the device by applying voltage signals to the device’s boot pins, with each boot pin corresponding to a bit of the boot value. For example, a device with sixteen boot pins requires a sixteen-bit boot value, whereas a device with only four boot pins requires a four-bit boot value. Problematically, including sixteen boot pins on the device increases the device cost, power consumption, and area. Conversely, limiting the device to only four boot pins reduces the flexibility in specifying primary and secondary boot sources.

In contrast, disclosed herein are techniques that allow a device to be initialized in accordance with either a sixteen-pin boot mode or a four-pin boot mode. In turn, the disclosed techniques provide a variety of boot options for initializing a device. As a result, the proposed technology reduces the overall system cost, power consumption, and area for a device.

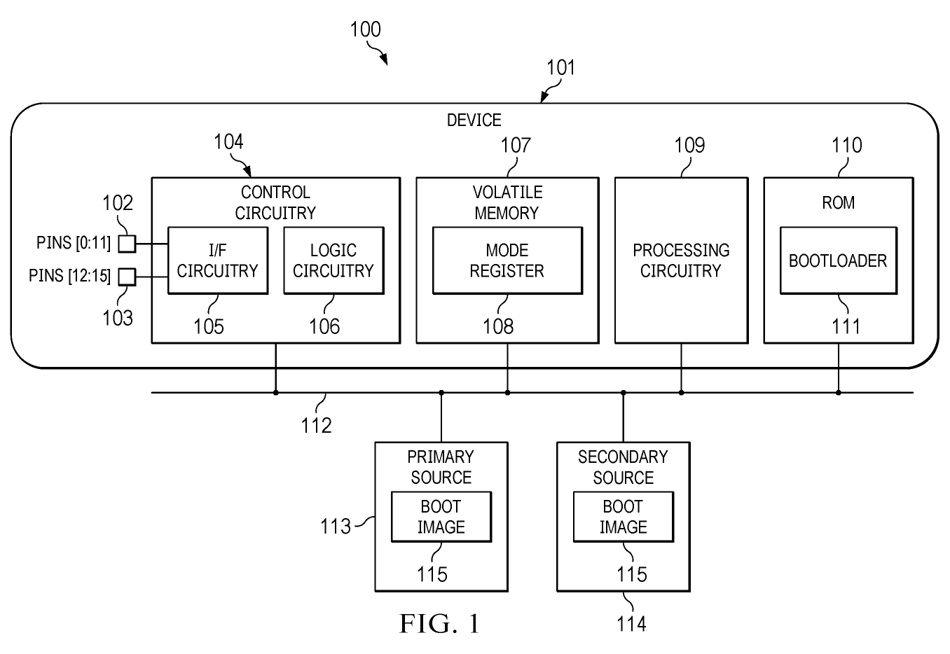

FIG. 1 illustrates system 100 in an implementation. System 100 is representative of an exemplary system that is capable of initiating a boot process in accordance with various pin configurations. For example, system 100 depicts a system on a chip (SoC) that is coupled to multiple boot sources and supports both limited-pin and full-pin configurations. A limited-pin configuration refers to a method for initializing a device that uses only a subset of the device’s boot pins. For example, if system 100 includes sixteen boot pins, then a limited-pin configuration utilizes, at a maximum, fifteen out of the sixteen boot pins to indicate a boot mode for performing the boot process. Alternatively, a full-pin configuration refers to a method for initializing a device that uses all of the device’s boot pins. For example, if system 100 includes sixteen boot pins, then a full-pin configuration utilizes all sixteen boot pins to indicate a boot mode for performing the boot process. As used herein, a boot mode refers to an indicator that specifies the primary and secondary boot sources for initializing a system. For example, system 100 may boot up in accordance with various limited-pin boot modes, programmable boot modes, or full-pin boot modes.

A limited-pin boot mode refers to a type of limited-pin configuration that utilizes a subset of the device’s boot pins to indicate the primary and secondary boot sources. Meanwhile, a programmable boot mode refers to another type of limited-pin configuration that utilizes a subset of the device’s boot pins to indicate user specific primary and secondary boot sources. Alternatively, a full-pin boot mode refers to a type of full-pin configuration that utilizes all of the device’s boot pins to indicate the primary and secondary boot sources.

In an implementation, when system 100 starts up, a voltage signal is applied to the boot pins of device 101 to cause device 101 to determine the pin configuration and boot mode for initiating the boot process. For example, device 101 first determines whether to boot system 100 in accordance with a limited-pin configuration or a full-pin configuration. If device 101 determines to boot system 100 in accordance with a limited-pin configuration, then device 101 determines which boot mode, from a set of limited-pin boot modes and programmable boot modes, to use to initiate the boot process. Alternatively, if device 101 determines to boot system 100 in accordance with a full-pin configuration, then device 101 determines which boot mode, from a set of full-pin boot modes, to use to initiate the boot process. System 100 includes, but is not limited to, device 101, bus 112, primary source 113, and secondary source 114.

Device 101 is representative of circuitry capable of initializing system 100. For example, device 101 depicts an SoC, microcontroller unit (MCU), application-specific integrated circuit (ASIC), or another device of the like that is capable of booting system 100 in accordance with a limited-pin configuration or a full-pin configuration. Device 101 includes, but is not limited to, pins 102, pins 103, control circuitry 104, volatile memory 107, processing circuitry 109, and read-only memory (ROM) 110. It should be noted that, while illustrated as components of device 101, pins 102 and 103, control circuitry 104, volatile memory 107, processing circuitry 109, and/or ROM 110 may be depicted as individual elements that are coupled to bus 112, but for the purposes of explanation, such components will be explained as being a part of device 101. This specification is not meant to limit the applications of pins 102 and 103, control circuitry 104, volatile memory 107, processing circuitry 109, and ROM 110, but rather to provide an example.

Pins 102 and pins 103 are representative of circuitry that provide connection points to device 101. For example, if device 101 includes sixteen pins, then pins 102 depict the first twelve pins of device 101, while pins 103 depict the remaining four pins of device 101. For the purposes of explanation, device 101 will be explained as having sixteen pins, with pins 102 including the first twelve pins (i.e., pin 0, pin 1, pin 2, pin 3, pin 4, pin 5, pin 6, pin 7, pin 8, pin 9, pin 10, and pin 11 of device 101) and pins 103 including the remaining four pins (i.e., pin 12, pin 13, pin 14, and pin 15 of device 101). This specification is not meant to limit the applications of device 101, but rather, to provide an example. In an implementation, each pin of pins 102 and 103 may either serve as a boot pin or a device pin during system startup. A boot pin refers to a connection point that has been configured to receive a voltage signal, while a device pin is a connection point that has been configured to interface with an external component. Accordingly, when a pin is configured to serve as a boot pin, the pin is connected to either a voltage source or ground via a resistor (e.g., pull-up resistor or pull-down resistor). Conversely, when a pin is configured to serve as a device pin, the pin is available to be connected to an external component and is no longer utilized for boot functions. For example, a device pin may be connected to an external sensor, switch, communication interface, memory device, or other circuitry of the like.

In an implementation, during system startup, the boot pins of device 101 are supplied with a configuration signal. The configuration signal is a voltage signal which corresponds to a binary value that indicates the pin configuration and corresponding boot mode for initializing system 100. For example, the configuration signal corresponds to either a 4-bit or 16-bit binary value. In an implementation, the configuration signal is applied to the boot pins through either a voltage source or ground connection. Prior to operation, each boot pin of device 101 is selectively coupled to a voltage source or ground based on the desired pin configuration and boot mode. When a boot pin is coupled to the voltage source, the corresponding bit of the configuration signal represents a high logic level (i.e., 1). Alternatively, when a boot pin is coupled to ground, the corresponding bit of the configuration signal represents a low logic level (i.e., 0). Accordingly, pins 103 capture the first four bits of the configuration signal, while pins 103 capture the remaining twelve bits of the configuration signal. In an implementation, pins 102 and 103 route the received configuration signals to control circuitry 104.

Control circuitry 104 is representative of circuitry that generates a boot value for executing the boot process. For example, control circuitry 104 is representative of a central processing unit (CPU), MCU, ASIC, or another general-purpose processor (GPP) of the like that is capable of converting a configuration signal into a boot value. As used herein, the boot value is representative of a binary value that indicates the pin configuration and corresponding boot mode for executing the boot process. Control circuitry 104 includes, but is not limited to, interface circuitry 105 and logic circuitry 106.

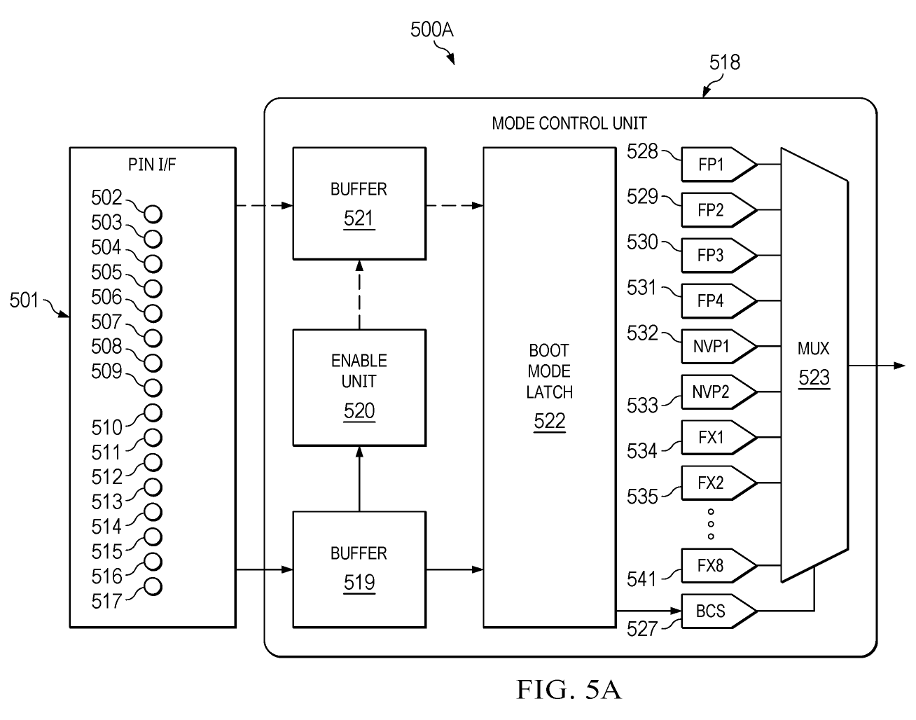

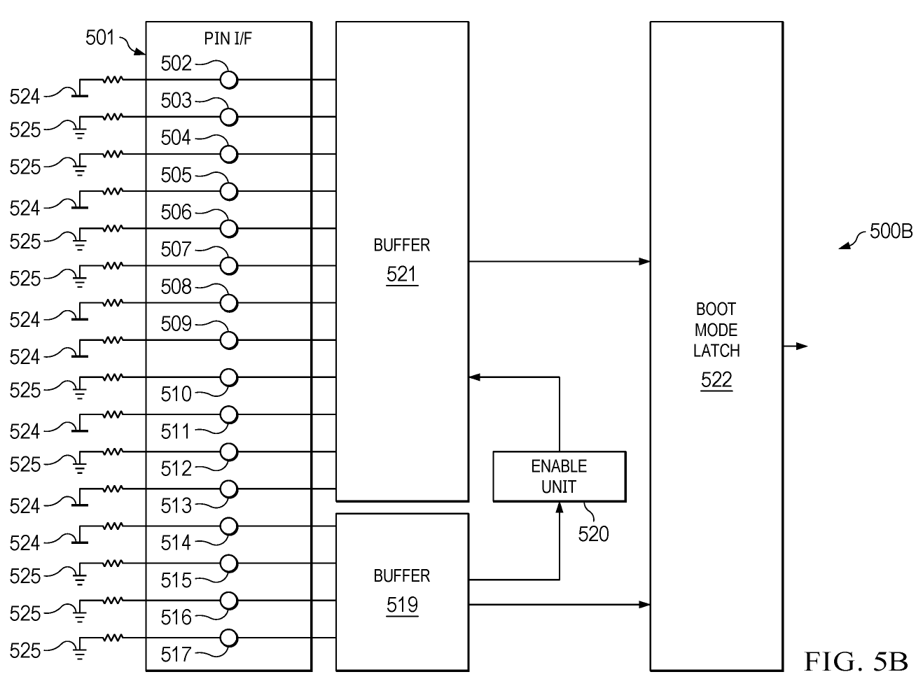

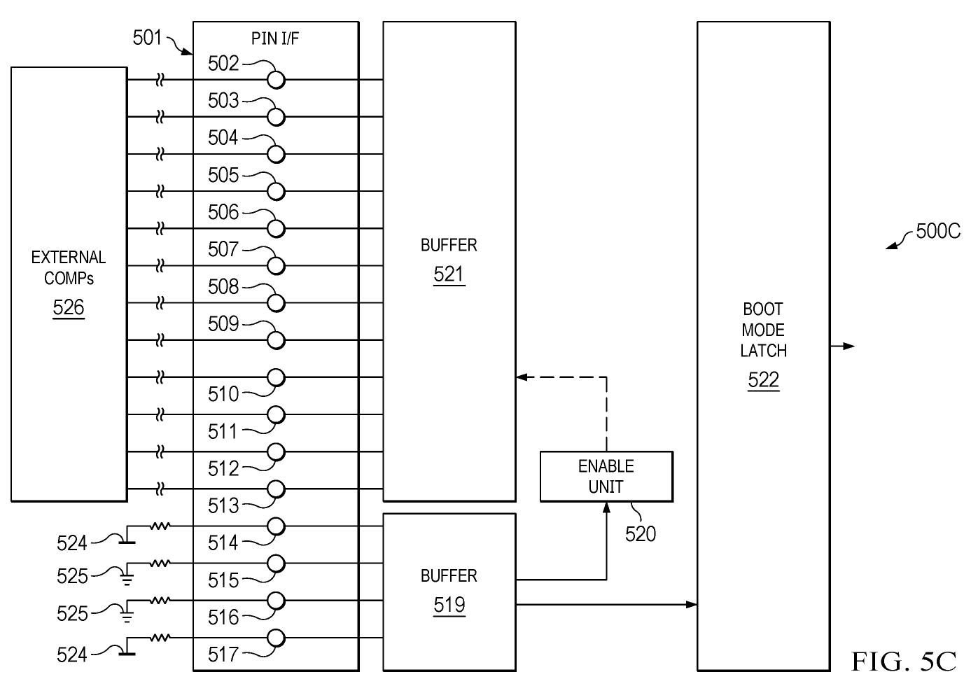

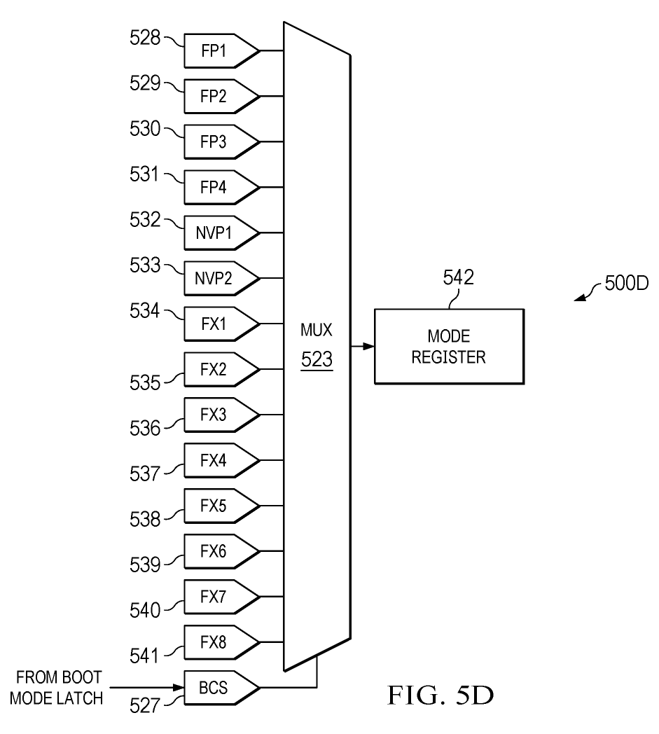

Interface circuitry 105 is representative of circuitry that connects pins 102 and 103 to the components of device 101. For example, interface circuitry 105 depicts a general-purpose input/output (GPIO) circuit that routes the configuration signal received at pins 102 and 103 to logic circuitry 106. In an implementation, interface circuitry 105 includes a first buffer coupled to pins 102 and a second buffer coupled to pins 103, later discussed in detail with reference to FIG. 5A.

Logic circuitry 106 is representative of circuitry that is capable of generating a boot value based on the configuration signal output by interface circuitry 105. For example, in response to receiving the configuration signal, logic circuitry 106 generates a boot value that identifies a limited-pin boot mode or programmable boot mode of a limited-pin configuration, or a full-pin boot mode of a full-pin configuration. In an implementation, the boot value for a limited-pin boot mode or a full-pin boot mode is representative of a 16-bit binary value that identifies the primary and secondary boot sources for initializing system 100. Alternatively, the boot value for a programmable boot mode is representative of a 16-bit binary value that indicates device 101 includes a boot unit for identifying the primary and secondary boot sources for initializing system 100. For example, the boot value for a programmable boot mode may indicate that device 101 includes an electronic fuse (eFUSE) device. In an implementation, logic circuitry 106 includes multiplexer circuitry that generates the boot value based on the received configuration signal. For example, logic circuitry 106 includes a multiplexer that, in response to receiving the configuration signal, outputs a boot value indicative of the boot mode to volatile memory 107, later discussed in detail with reference to FIG. 5D.

Volatile memory 107 is representative of a memory that stores instructions, data, and the like for device 101. For example, volatile memory 107 depicts random-access memory (RAM), dynamic RAM (DRAM), static RAM (SRAM), or another type of volatile memory, such that in no case is volatile memory 107 representative of a propagated signal. Volatile memory 107 includes, but is not limited to, mode register 108.

Mode register 108 is representative of a register that stores the boot value generated by logic circuitry 106. For example, after generating the boot value, logic circuitry 106 outputs the generated boot value to mode register 108, and in response, processing circuitry 109 reads the boot value from mode register 108.

Processing circuitry 109 is representative of circuitry that executes program code for initializing system 100 and subsequently operating system 100 after initialization. For example, processing circuitry 109 depicts a CPU, MCU, ASIC, or another GPP capable of executing the program code stored by volatile memory 107 and ROM 110. In an implementation, during system initialization, processing circuitry 109 is triggered to execute the bootloader stored by ROM 110.

ROM 110 is representative of a non-volatile memory that stores instructions, data, and the like for device 101. It should be noted that ROM 110 is representative of any type of non-volatile memory, but for the purposes of explanation, ROM will be discussed herein. This specification is not meant to limit the applications of device 101, but rather, to provide an example. Additionally, it should be noted that in no case is ROM 110 representative of a propagated signal. In an implementation, ROM 110 stores bootloader 111 for execution by processing circuitry 109.

Bootloader 111 is representative of program code that causes processing circuitry 109 to initiate the boot process. More specifically, when executed by processing circuitry 109, bootloader 111 causes processing circuitry 109 to read the 16-bit boot value stored by mode register 108 to determine the primary and secondary boot sources for initializing system 100. Once determined, bootloader 111 then causes processing circuitry 109 to transfer application-specific program code from either the primary or secondary boot source to volatile memory 107 via bus 112.

Bus 112 is representative of circuitry that facilitates communication across system 100. For example, bus 112 depicts an interconnect, event fabric, or another data bus of the like that enables the transfer of data between device 101, primary source 113, and secondary source 114.

Primary source 113 and secondary source 114 are representative of off-chip interfaces that store program code for device 101. For example, primary source 113 and secondary source 114 may each represent a Universal Serial Bus (USB) device, a flash memory device, an Ethernet interface, or another type of off-chip storage/communication interface of the like. It should be noted that primary source 113 and secondary source 114 may depict the same or different kinds of interfaces. Additionally, in no case are primary source 113 and secondary source 114 representative of propagated signals. In an implementation, both primary source 113 and secondary source 114 store boot image 115.

Boot image 115 is representative of application-specific program code. For example, boot image 115 includes program code that is tailored to the environment in which device 101 is implemented. In an implementation, boot image 115 includes user provided program code. For example, a user may generate boot image 115 and store boot image 115 in primary source 113 and secondary source 114. Then, during system initialization, processing circuitry 109 first attempts to access boot image 115 from primary source 113. If successful, processing circuitry 109 transfers boot image 115 from primary source 113 to volatile memory 107 via bus 112. Alternatively, if processing circuitry 109 is unable to access boot image 115 from primary source 113, then processing circuitry 109 attempts to access boot image 115 from secondary source 114. If successful, processing circuitry 109 transfers boot image 115 from secondary source 114 to volatile memory 107 via bus 112. Alternatively, if processing circuitry 109 is unable to access boot image 115 from secondary source 114, then processing circuitry 109 issues a warning indicating that the boot process failed.

In an implementation, device 101 is configured to boot system 100 in accordance with a specific boot mode. For example, device 101 may be configured to boot system 100 in accordance with a limited-pin boot mode, a programmable boot mode, or a full-pin boot mode. If device 101 is configured to boot system 100 in accordance with a limited-pin boot mode, then pins 102 are coupled to external components while pins 103 are coupled to a voltage source or ground via a corresponding resistor. Conversely, if device 101 is configured to boot system 100 in accordance with a programmable boot mode, then pins 102 are coupled to external components, pins 103 are coupled to a voltage source or ground via a corresponding resistor, and device 101 either includes or is coupled to an associated boot device (e.g., eFUSE device). Alternatively, if device 101 is configured to boot system 100 in accordance with a full-pin boot mode, then each pin of pins 102 and 103 is coupled to a voltage source or ground via a corresponding resistor. Accordingly, if device 101 is configured to boot system 100 in accordance with a limited-pin boot mode or a programmable boot mode, then the number of pull-up or pull-down resistors coupled to the boot pins of system 100 is reduced. As a result, the proposed technology reduces the system cost and power consumption, while increasing the available board area.

In an implementation, to configure device 101 to operate in accordance with a specific boot mode, pins 102 and 103 are selectively connected to either an external component, a voltage source, or ground. For example, to configure device 101 to operate in accordance with a specific limited-pin boot mode, pins 102 are connected to external components and pins 103 are connected to a voltage source or ground in an arrangement that corresponds to the boot value for that specific limited-pin boot mode. Meanwhile, to configure device 101 to operate in accordance with a specific programmable boot mode, pins 102 are connected to external components, pins 103 are connected to a voltage source or ground in an arrangement that corresponds to the boot value for that specific programmable boot mode, and an associated boot device is connected to logic circuitry 106. Alternatively, to configure device 101 to operate in accordance with a specific full-pin boot mode, pins 102 and 103 are connected to a voltage source or ground in an arrangement that corresponds to the boot value for that specific full-pin boot mode. Accordingly, device 101 provides flexibility in selecting a desired pin configuration (i.e., limited-pin or full-pin configuration) and a corresponding boot mode (i.e., limited-pin boot mode, programmable boot mode, and full-pin boot mode) for performing the system initialization.

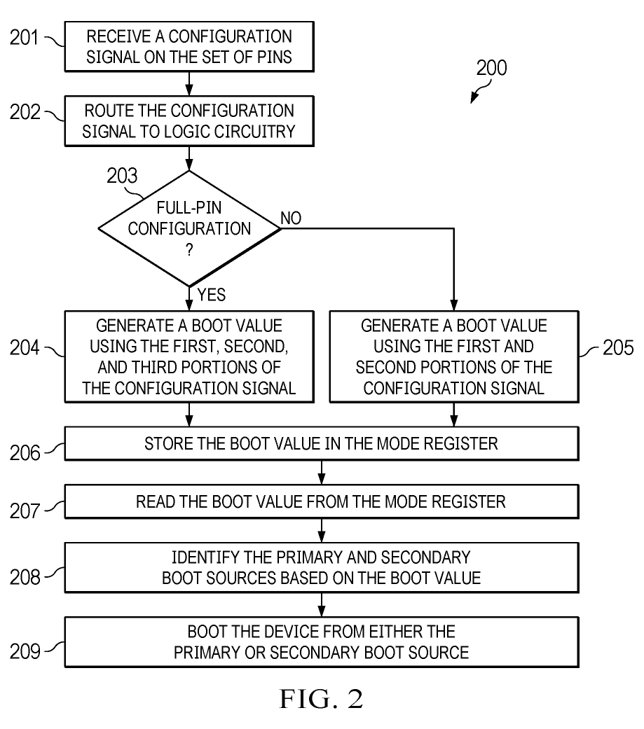

FIG. 2 illustrates boot method 200 in an implementation. Boot method 200 is representative of a technique for booting up a device in accordance with either a limited-pin configuration or a full-pin configuration. For example, boot method 200 provides a technique for booting system 100 in accordance with a limited-pin boot mode, programmable boot mode, or full-pin boot mode. Boot method 200 may be implemented in the context of hardware, firmware, or software to cause a system to operate as follows, referring parenthetically to the steps in FIG. 2. For the purposes of explanation, boot method 200 will be explained with respect to the elements of FIG. 1, such that device 101 includes sixteen pins, pins 102 include pin 0, pin 1, pin 2, pin 3, pin 4, pin 5, pin 6, pin 7, pin 8, pin 9, pin 10, and pin 11 of device 101, while pins 103 include pin 12, pin 12, pin 14, and pin 15 of device 101. This specification is not meant to limit the applications of boot method 200, but rather to provide an example.

To begin, device 101 receives a configuration signal on a set of pins (step 201). For example, if device 101 is configured to boot system 100 in accordance with a limited-pin configuration, then pins 103 are supplied with a configuration signal that corresponds to a boot value for either a specific limited-pin boot mode or a specific programmable boot mode. Alternatively, if device 101 is configured to boot system 100 in accordance with a full-pin configuration, then pins 102 and pins 103 are supplied with a configuration signal that corresponds to a boot value for a specific full-pin boot mode.

In an implementation, upon receiving the configuration signal, the boot pins of device 101 route the configuration signal to logic circuitry 106 (step 202). For example, the boot pins route the configuration signal to logic circuitry 106 via interface circuitry 105. In response, logic circuitry 106 determines whether device 101 is configured to boot system 100 in accordance with a limited-pin configuration or a full-pin configuration based on the configuration signal (step 203). In an implementation, to determine the pin configuration that system 100 is configured to boot in accordance with, logic circuitry 106 analyzes the portion of the configuration signal that was received on a subset of pins 103. For example, logic circuitry 106 determines if system 100 is configured to boot in accordance with a limited-pin configuration or a full-pin configuration based on the voltage levels that are applied to pin 14 and pin 15 of pins 103. More specifically, logic circuitry 106 determines if the combination of bits corresponding to said portion of the configuration signal consists of only bits having a first logic value or includes at least one bit having second logic value. In an example, the first logic value is 0 and the second logic value is 1. In another embodiment, the first logic value is 1 and the second logic value is 0.

If pin 14 or pin 15 of pins 103 is coupled to a voltage source, then logic circuitry 106 determines system 100 is configured to boot in accordance with a limited-pin configuration. Alternatively, if pin 14 and pin 15 of pins 103 are coupled to ground, then logic circuitry 106 determines system 100 is configured to boot in accordance with a full-pin configuration. More generally, if a combination of the two bits corresponding to said portion of the configuration signal includes a one, then logic circuitry 106 determines that system 100 is configured to boot in accordance with either a limited-pin boot mode or a programmable boot mode of a limited-pin configuration. Alternatively, if the combination of the two bits corresponding to said portion of the configuration signal consists of zeros, then logic circuitry 106 determines system 100 is configured to boot in accordance with a full-pin boot mode of a full-pin configuration.

If logic circuitry 106 determines that the combination of the two bits consists of zeros, then logic circuitry 106 concludes that device 101 is configured to boot system 100 in accordance with a full-pin boot mode of a full-pin configuration. Next, logic circuitry 106 generates a boot value by using the first, second, and third portions of the configuration signal (step 204). For example, logic circuitry 106 generates the boot value by using the twelve bits that are represented by pin 0, pin 1, pin 2, pin 3, pin 4, pin 5, pin 6, pin 7, pin 8, pin 9 ,pin 10, and pin 11 of pins 102 (i.e., the third portion of the configuration signal), the two bits that are represented by pins 12 and 13 of pins 103 (i.e., the second portion of the configuration signal), and the two bits that are represented by pins 14 and 15 of pins 103 (i.e., the first portion of the configuration signal). As a result, logic circuitry 106 generates a 16-bit boot value that identifies the desired full-pin boot mode and corresponds to the voltage levels that were applied to pins 102 and 103.

Alternatively, if logic circuitry 106 determines that the combination of the two bits includes a one, then logic circuitry 106 concludes that device 101 is configured to boot up in accordance with either a limited-pin boot mode or a programmable boot mode of a limited-pin configuration. Next, logic circuitry 106 generates a boot value by using the first and second potions of the configuration signal (step 205). For example, logic circuitry 106 first generates a 4-bit value by using the two bits that are represented by pins 12 and 13 of pins 103 (i.e., the second portion of the configuration signal), and the two bits that are represented by pins 14 and 15 of pins 103 (i.e., the first portion of the configuration signal). Once generated, logic circuitry 106 converts the 4-bit value into a corresponding 16-bit boot value. For example, logic circuitry 106 includes a look-up table that stores the corresponding 16-bit boot values for each possible limited-pin boot mode and programmable boot mode.

In an implementation, after generating the boot value, logic circuitry 106 stores the boot value in mode register 108 (step 206). Once stored, bootloader 111 causes processing circuitry 109 to read the boot value from mode register 108 (step 207). As a result, processing circuitry 109 identifies the primary and secondary boot sources based on the boot value (step 208). For example, processing circuitry 109 may determine that the boot value identifies primary source 113 and secondary source 114. Next, processing circuitry 109 boots system 100 from either primary source 113 or secondary source 114(step 209).

For example, processing circuitry 109 first attempts to access boot image 115 from primary source 113. If successful, processing circuitry 109 transfers boot image 115 from primary source 113 to volatile memory 107 and continues with normal operations. Alternatively, if unsuccessful, processing circuitry 109 then attempts to access boot image 115 from secondary source 114. If successful, processing circuitry 109 transfers boot image 115 from secondary source 114 to volatile memory 107 and continues with normal operations. Alternatively, if unsuccessful, processing circuitry 109 issues a warning indicating that the boot process failed.

Advantageously, boot method 200 provides a technique that allows device 101 to boot system 100 in accordance with a limited-pin boot mode, a programmable boot mode, or a full-pin boot mode. As a result, boot method 200 provides flexibility to the user in selecting a boot mode for initializing system 100. Additionally, boot method 200 leverages existing bootloader architectures, such as bootloader 111, by implementing 16-bit boot values. Accordingly, boot method 200 avoids the expenses associated with updating bootloader 111 by maintaining compatibility with existing bootloader implementations. Boot method 200 also reduces overall cost and power consumption of system 100, while increasing the available area on device 101 for when a limited-pin boot mode is selected. In particular, selecting a limited-pin boot mode reduces the number of resistors within device 101 that draw power continuously, which correspondingly decreases the cost and power consumption of system 100, while increasing the available board area.

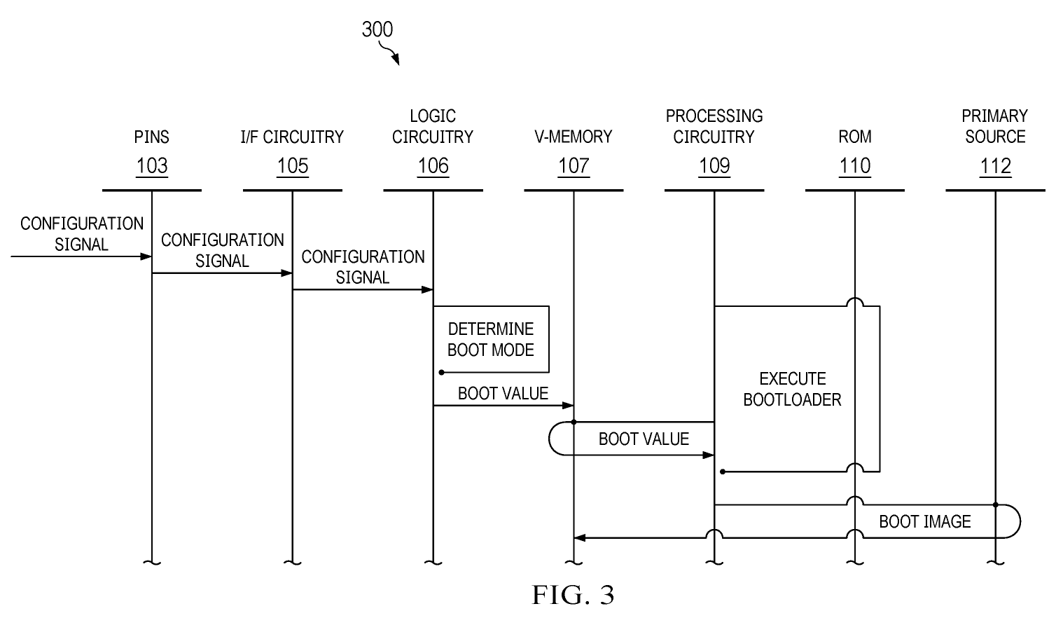

FIG. 3 illustrates sequence diagram 300 in an implementation. Sequence diagram 300 is representative of an operational sequence for initializing a system. For the purposes of explanation, sequence diagram 300 will be explained with reference to FIG. 1. More specifically, sequence diagram 300 will be explained with reference to device 101 including sixteen pins and being configured to boot in accordance with a limited-pin boot mode of a limited-pin configuration. This specification is not meant to limit the applications of sequence diagram 300, but rather, to provide an example. Sequence diagram 300 includes pins 103, interface circuitry 105, logic circuitry 106, volatile memory 107, processing circuitry 109, ROM 110, and primary source 113.

To begin, pins 103 are supplied with a 4-bit configuration signal that is routed across interface circuitry 105 to logic circuitry 106. The 4-bit configuration signal is representative of a voltage signal that describes the logic levels that were applied to pins 103. For example, the configuration signal may indicate that pin 15 of pins 103 is coupled to a voltage source, while pin 12, pin 13 and pin 14 of pins 103 are coupled to ground.

Next, logic circuitry 106 determines the desired pin configuration and corresponding boot mode for initializing device 101, while processing circuitry 109 simultaneously begins executing bootloader 111 from ROM 110. In an implementation, to determine the desired pin configuration, logic circuitry 106 analyzes the last two bits of the configuration signal. For example, logic circuitry 106 analyzes the portion of the configuration signal that was applied to pins 14 and 15 of pins 103 to determine if the combination of the two bits consists of zeros or includes a one.

In response to determining that the combination of the two bits includes a one, logic circuitry 106 concludes that device 101 is configured to boot up in accordance with a limited-pin configuration. Next, logic circuitry 106 determines whether the applied configuration signal corresponds to a limited-pin boot mode or a programmable boot mode. In an implementation, to determine whether the applied configuration signal corresponds to a limited-pin boot mode or a programmable boot mode, logic circuitry 106 analyzes the portion of the configuration signal that was applied to pin 15 of pins 103. For example, logic circuitry 106 determines if the bit represented by said portion of the configuration signal corresponds to a binary value of 1 or 0. In an implementation, if logic circuitry 106 determines that the bit captured on pin 15 of pins 103 corresponds to a binary value of 1, then logic circuitry 106 concludes that system 100 is configured to boot in accordance with a limited-pin boot mode. Alternatively, if logic circuitry 106 determines that the bit captured on pin 15 of pins 103 corresponds to a binary value of 0, then logic circuitry 106 concludes that system 100 is configured to boot in accordance with a programmable boot mode.

Next, after concluding that system 100 is configured to boot in accordance with a limited-pin boot mode, logic circuitry 106 analyzes the entire configuration signal to determine which limited-pin boot mode that system 100 is configured to boot in accordance with. For example, logic circuitry 106 converts the configuration signal into a 4-bit value that corresponds to a specific limited-pin boot mode. Logic circuitry 106 then converts the 4-bit value into a corresponding 16-bit boot value that identifies the primary and secondary boot sources defined by the specific limited-pin boot mode. For example, logic circuitry 106 converts the 4-bit value into a 16-bit boot value that identifies primary source 113 and secondary source 114. Once converted, logic circuitry 106 stores the 16-bit boot value in mode register 108 of volatile memory 107.

Finally, bootloader 111 causes processing circuitry 109 to read the boot value from mode register 108 to identify the primary and secondary boot sources for initializing device 101. For example, the boot value includes fields that identify primary source 113 as the first boot source and secondary source 114 as the second boot source. Once identified, bootloader 111 causes processing circuitry 109 to attempt to access boot image 115 from primary source 113. If successful, processing circuitry 109 stores boot image 115 in volatile memory 107. Conversely, if unsuccessful, processing circuitry 109 then attempts to access boot image 115 from secondary source 114.

Advantageously, sequence diagram 300 illustrates an exemplary scenario for when a limited-pin boot mode is selected. Accordingly, sequence diagram 300 illustrates a scenario that leverages existing bootloader architectures, reduces the cost and power consumption of system 100, and increases the available area on device 101.

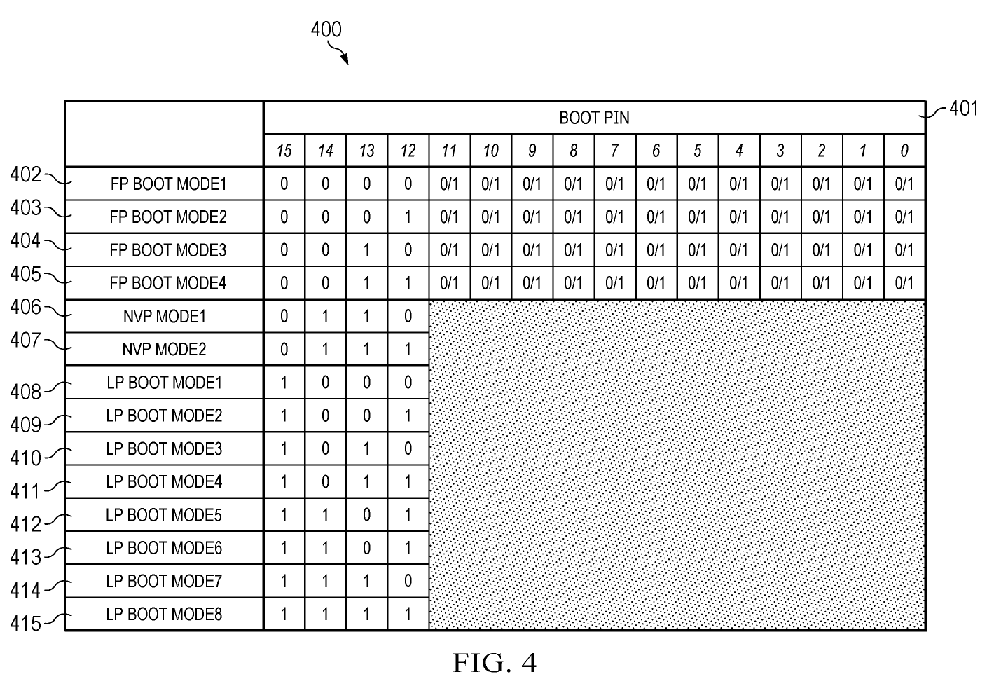

FIG. 4 illustrates boot mode table 400 in an implementation. Boot mode table 400 is representative of an exemplary table that provides the pin settings for configuring a device including sixteen pins to operate in accordance with either a limited-pin configuration or a full-pin configuration. For example, boot mode table 400 provides the pin settings for configuring system 100 to boot in accordance with a limited-pin boot mode or a programmable boot mode of a limited-pin configuration, or a full-pin boot mode of a full-pin configuration. Boot mode table 400 includes boot pin columns 401, full-pin boot mode rows 402-405, programmable boot mode rows 406-407, and limited-pin boot mode rows 405-412.

Boot pin columns 401 represent sixteen columns that specify the pin settings for the possible boot modes. Accordingly, boot pin columns 401 indicate which pins are coupled to a voltage source and which pins are coupled to ground for a given boot mode. In other words, boot pin columns 401 depict the configuration signal for employing a specific boot mode on a device that includes sixteen pins (e.g., device 101).

Full-pin boot mode rows 402, 403, 404, and 405 are representative rows that identify the pin settings for configuring a device to operate in accordance with a specific full-pin boot mode. As such, the pin settings identified by full-pin boot mode rows 402, 403, 404, and 405 define the primary and secondary boot sources for booting a device in accordance with a respective full-pin boot mode. It should be noted that, full-pin boot mode rows 402, 403, 404, and 405 are indicative of exemplary full-pin boot mode options, and a device including sixteen pins is not limited to booting in accordance with the boot modes identified by full-pin boot mode rows 402, 403, 404, and 405. Instead, the device may be configured to boot in accordance with at least 64,000 different full-pin boot modes, as long as pin 15 and pin 14 of the device are coupled to ground (i.e., 00).

Programmable boot mode rows 406 and 407 are representative of rows that identify the pin settings for configuring a device to operate in accordance with a specific non-volatile programmable (NVP) boot mode. An NVP boot mode refers to a user configurable boot mode. For example, an NVP boot mode may correspond to an eFUSE-based boot configuration in which a user programs the desired primary and secondary sources via an eFUSE device. Accordingly, the pin settings identified by programmable boot mode rows 406 and 407 indicate that the boot value for a corresponding NVP boot mode will be supplied by associated boot circuitry. In an implementation, programmable boot mode rows 406 and 407 provide two possible NVP boot modes for booting up a system. Accordingly, programmable boot mode rows 406 and 407 provides built-in redundancy for the NVP boot modes. In an implementation, programmable boot mode rows 406 and 407 define the pin settings for at least pin 15 and pin 14 of a device. For example, a device may be configured to boot in accordance with at least 32,000 different NVP boot modes, as long as pin 15 and pin 14 of the device are respectively coupled to a voltage source and ground (i.e., 01). In an implementation, the NVP boot modes of programmable boot mode rows 406 and 407 are representative of one-time programmable (OTP) boot modes. In another implementation, the NVP boot modes of programmable boot mode rows 406 and 407 are representative of multi-programmable boot modes.

Limited-pin boot mode rows 408, 409, 410, 411, 412, 413, 414, and 415 are each representative of a row that identifies the pin settings for configuring a device to operate in accordance with a specific limited-pin boot mode. As such, the pin settings identified by limited-pin boot mode rows 408, 409, 410, 411, 412, 413, 414, and 415 respectively define the primary and secondary boot sources for booting a device in accordance with a first, second, third, fourth, fifth, sixth, seventh, or eighth limited-pin boot mode. For example, a device may be configured to operate in accordance with the first limited-pin boot mode when pins 15, 14, 13, and 12 of the device are coupled to a voltage source or ground in a manner that corresponds to a binary value of 1000. Alternatively, the device may be configured to operate in accordance with the second limited-pin boot mode when pins 15, 14, 13, and 12 of the device are coupled to a voltage source or ground in a manner that corresponds to a binary value of 1001. It should be noted that, the limited-pin boot modes identified by limited-pin boot mode rows 408-415 are not limited to 4-pin configurations, and may instead be employed via 5-pin configurations, 6-pin configurations, or another pin configuration that utilizes less pins than the available amount.

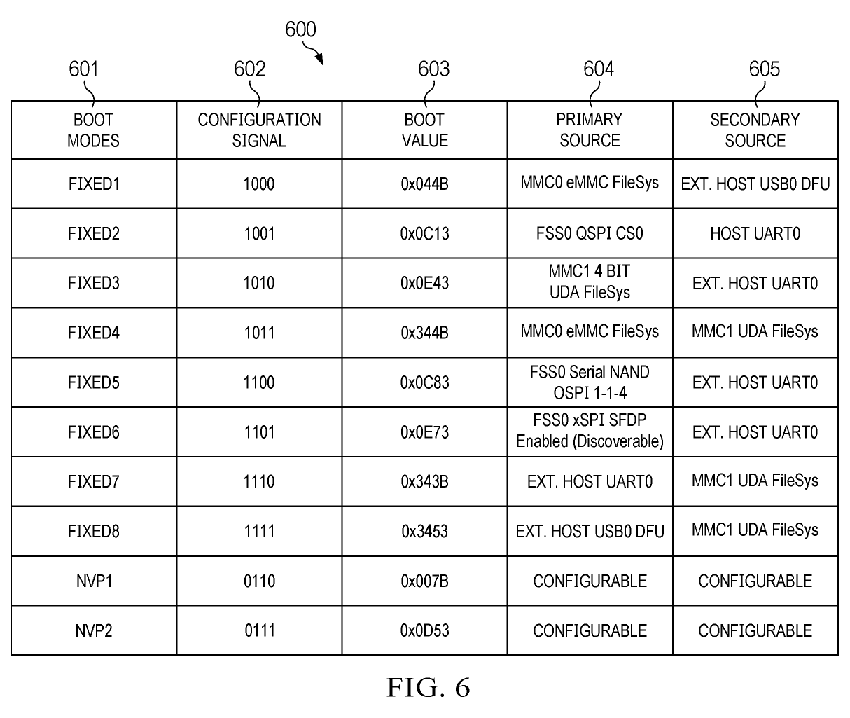

In an implementation, the limited-pin boot modes identified by limited-pin boot mode rows 408, 409, 410, 411, 412, 413, 414, and 415 are representative of a set of common boot modes. For example, limited-pin boot mode row 408 corresponds to a first common boot mode, limited-pin boot mode row 409 corresponds to a second common boot mode, limited-pin boot mode row 410 corresponds to a third common boot mode, limited-pin boot mode row 411 corresponds to a fourth common boot mode, limited-pin boot mode row 412 corresponds to a fifth common boot mode, limited-pin boot mode row 413 corresponds to a sixth common boot mode, limited-pin boot mode row 414 corresponds to a seventh common boot mode, and limited-pin boot mode row 415 corresponds to an eighth common boot mode. As used herein, a common boot mode refers to a type of boot mode that identifies common primary and secondary boot source options, later discussed in detail with reference to FIG. 6.

FIGS. 5A-5D illustrate the components of a control unit in various implementations. For example, FIGS. 5A-5D illustrate the components of control circuitry 104 of FIG. 1. Now turning to the first figure, FIG. 5A illustrates system 500A in an implementation. System 500A is representative of circuitry capable of generating a boot value based on a received configuration signal. System 500A includes, but is not limited to, pin interface 501 and mode control unit 518.

Pin interface 501 is representative of circuitry that provides connection points to mode control unit 518. In an implementation, pin interface 501 includes sixteen pins (i.e., pin 502-517) that may be configured as either a device pin or a boot pin. A device pin refers to a connection point that is available to interface with an external component, while a boot pin refers to a connection point that has been configured to receive a voltage signal. For example, if system 500A is configured to boot up in accordance with a limited-pin configuration, then pins 502-513 are configured as device pins, while pins 514-517 are configured as boot pins. Alternatively, if system 500A is configured to boot up in accordance with a full-pin configuration, then pins 502-517 are all configured as boot pins. It should be noted that in any case, pins 514-517 are configured as boot pins during system initialization.

In an implementation, during system startup, the boot pins of pin interface 501 are supplied with a configuration signal. The configuration signal is representative of a voltage signal that indicates the pin configuration and corresponding boot mode for initializing a system. Accordingly, the configuration signal corresponds to a binary value which identifies the desired boot mode for initializing system 500A. In an implementation, the configuration signal corresponds to either a 4-bit or 16-bit binary value. For example, if system 500A is configured to boot up in accordance with either a limited-pin boot mode or a NVP boot mode, then the configuration signal corresponds to a 4-bit value. Alternatively, if system 500A is configured to boot up in accordance with a full-pin boot mode, then the configuration signal corresponds to a 16-bit value. In either case, the boot pins of pin interface 501 route the received configuration signal to mode control unit 518.

Mode control unit 518 is representative of circuitry capable of converting a configuration signal into a binary value. Mode control unit 518 includes, but is not limited to, buffer 519, enable unit 520, buffer 521, boot mode latch 522, and multiplexer (MUX) 523.

Buffer 519 is representative of input circuitry that is capable of receiving the configuration signal that is applied to pins 514-517. For example, buffer 519 depicts a temporary memory location capable of receiving a 4-bit configuration signal. In an implementation, buffer 519 routes the received configuration signal to enable unit 520, and in response, enable unit 520 determines whether to enable buffer 521.

Enable unit 520 is representative of logic circuitry that is capable of determining the pin configuration for a device. For example, enable unit 520 determines if system 500A is configured to boot in accordance with a limited-pin configuration or a full-pin configuration based on the portion of the configuration signal that is received on pins 516 and 517. More specifically, enable unit 520 determines if the combination of bits corresponding to said portion of the configuration signal consists of only bits having a first logic value or includes at least one bit having second logic value. In an example, the first logic value is 0 and the second logic value is 1. In another embodiment, the first logic value is 1 and the second logic value is 0. If enable unit 520 determines that the combination of the bits consists of zeros (i.e., 00), then enable unit 520 concludes system 500A is configured to boot in accordance with a full-pin configuration and responsively enables buffer 521. Alternatively, if enable unit 520 determines that the combination of bits includes a one (i.e., 11, 01, or 10), then enable unit 520 concludes system 500A is configured to boot in accordance with a limited-pin configuration and responsively keeps buffer 521 disabled.

Buffer 521 is representative of input circuitry that is capable of receiving the configuration signal that is applied to pins 502-513. For example, buffer 519 depicts a temporary memory location capable of receiving a 12-bit configuration signal. In an implementation, buffer 521 remains disabled until enabled by enable unit 520. When disabled, the configuration signal received by pins 502–513 is prevented from reaching buffer 521. Alternatively, when enabled, the configuration signal is passed from pins 502–513 to buffer 521. In an implementation, if buffer 521 is enabled, then buffer 519 and buffer 521 route the received configuration signal to boot mode latch 522. Alternatively, if buffer 521 is disabled, then buffer 519 routes the received configuration signal to boot mode latch 522, and buffer 521 does not route the received configuration signal to boot mode latch 522.

Boot mode latch 522 is representative of circuitry that converts received configuration signals into a corresponding binary value. For example, boot mode latch 522 depicts a logic circuit that samples the configuration signal received from the boot pins and latches the resulting logic states as a binary value. If system 500A is configured to boot in accordance with a limited-pin configuration, then the binary value generated by boot mode latch 522 is 4-bits long. Alternatively, if system 500A is configured to boot in accordance with a full-pin configuration, then the binary value generated by boot mode latch 522 is 16-bits long. In an implementation, if system 500A is configured to boot in accordance with a limited-pin configuration, then boot mode latch 522 supplies the 4-bit binary value as a selector signal to selector 527 of MUX 523. Alternatively, if system 500A is configured to boot in accordance with a full-pin configuration, then boot mode latch 522 supplies the 16-bit binary value as a selector signal to selector 527 of MUX 523.

It should be noted that in alternative implementations, if system 500A is configured to boot in accordance with a full-pin configuration, then boot mode latch 522 supplies the first four bits of the binary value as a selector signal to selector 527, and supplies the full binary value to an input (e.g., input 528) of MUX 523. However, in other implementations, if system 500A is configured to boot in accordance with a full-pin configuration, then boot mode latch 522 bypasses MUX 523 and supplies the binary value directly to a mode register (e.g., mode register 542). In such implementations, boot mode latch 522 (or other circuitry) disables MUX 523 from supplying a binary value to the mode register.

MUX 523 is representative of logic circuitry that outputs a boot value for initializing system 500A. The boot value is a 16-bit binary value that indicates the desired pin configuration and boot mode for initializing system 500A. Accordingly, the boot value for a limited-pin or full-pin boot mode identifies the corresponding primary and secondary boot sources, while the boot value for an NVP boot mode indicates system 500A includes a boot device for specifying the corresponding primary and secondary boot sources. In an implementation, MUX 523 includes multiple inputs that have been hardcoded with 16-bit binary values. For example, the inputs corresponding to the limited-pin boot modes (e.g., inputs 534-541) may each be hardcoded with a corresponding 16-bit boot value. In another implementation, each input of MUX 523 (i.e., inputs 528–541) is coupled to circuitry that provides the respective 16-bit boot value. For example, a first set of inputs are coupled to registers (not shown) storing 16-bit boot values for the limited-pin and full-pin boot modes, while a second set of inputs are coupled to an eFUSE device that generates the boot value for the NVP boot modes. In either implementation, based on the selector signal provided to selector 527, MUX 523 selects one of these inputs and routes the corresponding 16-bit boot value to mode register 542, later discussed in detail with reference to FIG. 5D.

Now turning to the next figure, FIG. 5B illustrates operational scenario 500B in an implementation. Operational scenario 500B is representative of a scenario for when system 500A is configured to boot in accordance with a full-pin boot mode of a full-pin configuration. Accordingly, pins 502-517 are coupled, via a resistor, to voltage source 524 and ground 525 in an arrangement that corresponds to the boot value for a specific full-pin boot mode (i.e., 0001101011001001). Operational scenario 500B includes pin interface 501, buffer 519, buffer 521, enable unit 520, boot mode latch 522, voltage source 524 and ground 525.

To begin, a configuration signal is applied to pins 502-517. For example, when system 500A starts up, voltage source 524 supplies a voltage signal to pins 502, 505, 508, 509, 511, 513, and 514, while pins 503, 504, 506, 507, 510, 512, 515, 516, and 517 are coupled to ground 525. Next, pins 514-517 supply the received configuration signal to buffer 519, and in response, buffer 519 routes the received configuration signal to enable unit 520. Enable unit 520 then analyzes the portion of the configuration signal that was received on pins 516 and 517 to determine whether to enable buffer 521, and in turn, whether system 500A is configured to boot in accordance with a limited-pin configuration or a full-pin configuration.

In an implementation, to determine whether to enable buffer 521, enable unit 520 analyzes the combination of bits corresponding to the portion of the configuration signal that was received on pins 516 and 517. If enable unit 520 determines that the combination of bits consists of zeros (i.e., pins 516 and 517 are coupled to ground 525), then enable unit 520 concludes system 500A is configured to boot in accordance with a full-pin configuration and responsively enables buffer 521. Alternatively, if enable unit 520 determines that the combination of bits includes a one (i.e., pins 516 and/or 517 are coupled to voltage source 524), then enable unit 520 concludes system 500A is configured to boot in accordance with a limited-pin configuration and responsively keeps buffer 521 disabled.

In response to determining that the combination of bits consists of zeros, enable unit 520 enables buffer 521. Next, buffers 519 and 521 route the received configuration signal to boot mode latch 522, and in response, boot mode latch 522 generates a 16-bit value that corresponds to the configuration signal (e.g., 0001_1010_1100_1001). Once generated, boot mode latch 522 supplies the first four bits of the 16-bit binary value as a selector signal to selector 527 and supplies the full 16-bit binary value to an input (e.g., input 528) of MUX 523. Alternatively, it should be noted that, boot mode latch 522 may bypass MUX 523 and supply the 16-bit binary value directly to mode register 542.

Now turning to the next figure, FIG. 5C illustrates operational scenario 500C in an implementation. Operational scenario 500C is representative of a scenario for when system 500A is configured to boot in accordance with either a limited-pin boot mode or a NVP boot mode of a limited-pin configuration. Accordingly, pins 502-513 are available to be coupled to external components 526 (e.g., peripherals, memory devices, sensors, or power circuitry), while pins 514-517 are coupled, via a resistor, to voltage source 524 and ground 525 in an arrangement that corresponds to the boot value for a specific limited-pin or NVP boot mode (i.e., 1001). Operational scenario 500C includes pin interface 501, buffer 519, buffer 521, enable unit 520, boot mode latch 522, voltage source 524, ground 525, and external components 526.

To begin, a configuration signal is applied to pins 514-517. For example, when system 500A starts up, voltage source 524 supplies a voltage signal to pins 514 and 517, while pins 515 and 516 are coupled to ground 525. Next, pins 514-517 supply the received configuration signal to buffer 519, and in response, buffer 519 routes the received configuration signal to enable unit 520. Enable unit 520 then analyzes the portion of the configuration signal that was received on pins 516 and 517 to determine whether to enable buffer 521, and in turn, whether system 500A is configured to boot in accordance with a limited-pin configuration or a full-pin configuration.

In an implementation, to determine whether to enable buffer 521, enable unit 520 determines if the combination of bits corresponding to the portion of the configuration signal that was received on pins 516 and 517 consists of zeros or includes a one. In response to determining that the combination of bits includes a one, enable unit 520 keeps buffer 521 disabled. Accordingly, enable unit 520 reduces the chances of power dissipation through pins 502-513. Next, buffer 519 routes the received configuration signal to boot mode latch 522, and in response, boot mode latch 522 generates a 4-bit value that corresponds to the configuration signal. For example, boot mode latch 522 outputs a binary value of 1001 to MUX 523.

Now turning to the next figure, FIG. 5D illustrates operational scenario 500D in an implementation. Operational scenario 500D is representative of a scenario for generating a boot value based on the binary value output by boot mode latch 522. Operational scenario 500D includes MUX 523, selector 527, input 528, input 529, input 530, input 531, input 532, input 533, input 534, input 535, input 536, input 537, input 538, input 539, input 540, input 541, and mode register 542.

Selector 527 is representative of a control input that indicates the desired boot mode for initializing system 500A. For example, selector 527 depicts a control line that couples MUX 523 to boot mode latch 522 and carries the selector signal output by boot mode latch 522. In an implementation, MUX 523 selects one of inputs 528-541 to serve as an output based on the selector signal output by boot mode latch 522.

Inputs 528-541 are representative of data inputs that provide the boot values for various limited-pin and full-pin configurations. For example, inputs 528, 529, 530, and 531 provide the 16-bit boot values for a set of full-pin boot modes, inputs 534, 535, 536, 537, 538, 539, 540, and 541 provide the 16-bit boot values for a set of limited-pin boot modes, and inputs 532 and 533 provide the 16-bit boot value for a specific NVP boot mode. In an implementation, inputs 528-531 and 534-541 are representative of inputs that have been hardcoded to store the 16-bit boot value for a corresponding limited-pin or full-pin boot mode. In another implementation, inputs 528-531 and 534-541 are coupled to registers that store the 16-bit boot values for the limited-pin and full-pin boot modes. Conversely, in other implementations, inputs 528-531 are coupled to boot mode latch 522. For example, boot mode latch may route a 16-bit boot value for a full-pin boot mode to input 528. Meanwhile, input 532 and/or input 533 are coupled to a respective eFUSE device that provides the 16-bit boot value for identifying the primary and secondary sources for a specific NVP boot mode.

It should be noted that all of inputs 528-541 may correspond to a specific type of boot mode. For example, inputs 528-541 may provide the 16-bit boot values for a set of full-pin boot modes or a set of limited-pin boot modes. Alternatively, inputs 528-541 may each be coupled to a boot device that generates a respective boot value for a corresponding NVP boot mode. In an implementation, MUX 523 determines which of inputs 528-541 to route to mode register 542 based on the binary value of selector 527.

Mode register 542 is representative of a register that stores the boot value output by MUX 523. In an implementation, mode register 542 is coupled to the processing circuitry which initiates the boot process. For example, in the context of FIG. 1, mode register 542 is coupled to processing circuitry 109.

To begin operational scenario 500D, boot mode latch 522 outputs a selector signal indicative of a binary value to selector 527. For example, the selector signal may be indicative of a 4-bit or 16-bit binary value that corresponds to a full-pin boot mode. In response, MUX 523 uses the selector signal to select one of inputs 528–531 and route the corresponding boot value to mode register 542. For example, logic circuitry of MUX 523 determines that the selector signal corresponds to the input index associated with input 528 and, in response, routes the 16-bit boot value of input 528 to mode register 542. Once stored by mode register 542, the associated processing circuitry reads the boot value from mode register 542 to determine the primary and secondary boot sources for initializing system 500A.

Alternatively, the selector signal may be indicative of a 4-bit binary value that corresponds to a limited-pin boot mode or NVP boot mode. In response, MUX 523 uses the selector signal to select one of inputs 532-541 and route the corresponding boot value to mode register 542. For example, logic circuitry of MUX 523 determines that the selector signal corresponds to the input index associated with input 539 and, in response, routes the 16-bit boot value of input 539 to mode register 542. Alternatively, the logic circuitry of MUX 523 may determine that the selector signal corresponds to the input index associated with input 533 and, in response, routes the 16-bit boot value generated by the boot device coupled to input 533 to mode register 542. Once stored by mode register 542, the associated processing circuitry reads the boot value from mode register 542 to determine the primary and secondary boot sources for initializing system 500A.

FIG. 6 illustrates boot mode table 600 in an implementation. Boot mode table 600 is representative of an exemplary table that provides the settings for configuring a device including at least four pins to operate in accordance with a limited-pin configuration. For example, boot mode table 600 provides the settings for configuring system 100 or system 500A to boot in accordance with either a limited-pin boot mode or an NVP boot mode of a limited-pin configuration. For the purposes of explanation, boot mode table 600 will be explained with respect to the elements of system 500A. This is not meant to limit the applications of boot mode table 600, but rather to provide an example. Boot mode table 600 includes boot mode column 601, configuration signal column 602, boot value column 603, primary source column 604, and secondary source column 605.

Boot mode column 601 is representative of a column that identifies the possible boot modes for booting up system 500A. For example, boot mode column 601 identifies eight possible limited-pin boot mode options (i.e., FIXED1-FIXED8) and two possible programmable boot mode options (i.e., NVP1 and NVP2) for initializing system 500A.

Configuration signal column 602 is representative of a column that indicates the pin arrangements for booting system 500A in accordance with one of the eight possible limited-pin boot modes or one of the two possible NVP boot modes. Accordingly, configuration signal column 602 indicates that pin 517 is coupled to voltage source 524 while pins 514-516 are coupled to ground 525 for booting system 500A in accordance with the first limited-pin boot mode (i.e., FIXED1), pins 514 and 517 are coupled to voltage source 524 while pins 515 and 516 are coupled to ground 525 for booting system 500A in accordance with the second limited-pin boot mode (i.e., FIXED2), pins 515 and 517 are coupled to voltage source 524 while pins 514 and 516 are coupled to ground 525 for booting system 500A in accordance with the third limited-pin boot mode (i.e., FIXED3), pins 514, 515, and 517 are coupled to voltage source 524 while pin 516 is coupled to ground 525 for booting system 500A in accordance with the fourth limited-pin boot mode (i.e., FIXED4), pins 516 and 517 are coupled to voltage source 524 while pins 514 and 515 are coupled to ground 525 for booting system 500A in accordance with the fifth limited-pin boot mode (i.e., FIXED5), pins 514, 516, and 517 are coupled to voltage source 524 while pin 515 is coupled to ground 525 for booting system 500A in accordance with the sixth limited-pin boot mode (i.e., FIXED6), pins 515-517 are coupled to voltage source 524 while pin 514 is coupled to ground 525 for booting system 500A in accordance with the seventh limited-pin boot mode (i.e., FIXED7), and pins 514-517 are coupled to voltage source 524 for booting system 500A in accordance with the eighth limited-pin boot mode (i.e., FIXED8). Additionally, configuration signal column 602 indicates that pins 515 and 516 are coupled to voltage source 524 while pins 514 and 517 are coupled to ground 525 for booting system 500A in accordance with the first programmable boot mode (i.e., NVP1), and pins 514-516 are coupled to voltage source 524 while pin 517 is coupled to ground 525 for booting system 500A in accordance with the second programmable boot mode (i.e., NVP2). As such, if system 500A is configured to boot in accordance with a limited-pin boot mode, then pin 517 is coupled to voltage source 524. Alternatively, if system 500A is configured to boot in accordance with an NVP boot mode, then pin 517 is coupled to ground 525.

Boot value column 603 is representative of a column that indicates the 16-bit boot value for each of the possible limited-pin configurations. Accordingly, boot value column 603 indicates that the boot value corresponding to the first limited-pin boot mode is represented by the hexadecimal (HEX) value of 0x044B, the boot value corresponding to the second limited-pin boot mode is represented by the HEX value of 0x0C13, the boot value corresponding to the third limited-pin boot mode is represented by the HEX value of 0x0E43, the boot value corresponding to the fourth limited-pin boot mode is represented by the HEX value of 0x344B, the boot value corresponding to the fifth limited-pin boot mode is represented by the HEX value of 0x0C83, the boot value corresponding to the sixth limited-pin boot mode is represented by the HEX value of 0x0E73, the boot value corresponding to the seventh limited-pin boot mode is represented by the HEX value of 0x343B, and the boot value corresponding to the eighth limited-pin boot mode is represented by the HEX value of 0x3453. Additionally, boot value column 603 indicates that the boot value corresponding to the first NVP boot mode is represented by the HEX value of 0x007B, and the boot value corresponding to the second NVP boot mode is represented by the HEX value of 0x0D53. It should be noted that, the boot values corresponding to the eight possible limited-pin boot modes identify the primary and secondary boot sources for initializing system 500A in accordance with one of the limited-pin boot modes. Alternatively, the boot values corresponding to the two possible NVP boot modes indicate that system 500A includes an boot device that specifies the primary and secondary boot sources for initializing system 500A in accordance with an NVP boot mode.

Primary source column 604 is representative of a column that indicates exemplary primary boot sources for each of the possible limited-pin configurations of a device. The primary source refers to the first boot source that system 500A attempts to access the boot image from. Accordingly, primary source column 604 indicates that the primary source for booting system 500A in accordance with the first, second, third, fourth, fifth, sixth, seventh, and eighth limited-pin boot modes respectively includes a MultiMediaCard (MMC) device coupled to the first MMC interface (i.e., MMC0), a Quad Serial Peripheral Interface (QSPI) flash device coupled to chip select 0 (CS0) of the first Flash Subsystem (FSS0), an MMC device coupled to the second MMC interface (i.e., MMC1) operating in a 4-bit mode, an MMC device coupled to the first MMC interface that provides the boot image using a supported file system, a Serial NAND flash device coupled to the FSS0 through a single-data-line SPI interface configured in 1-1-4 mode, an extended Serial Peripheral Interface (xSPI) flash device coupled to the FSS0 that supports Serial Flash Discoverable Parameters (SFDP) for automatic boot image discovery, an external host device coupled to UART0, and an external host device coupled to USB0. Additionally, primary source column 604 indicates that the primary sources for booting system 500A in accordance with either the first or second NVP boot modes are configurable. As such, a user may define the primary source for either the first or second programmable boot modes via an associated boot device.

Secondary source column 605 is representative of a column that indicates exemplary secondary boot sources for each of the possible limited-pin configurations of a device. The secondary source refers to the back-up boot source from which system 500A attempts to access the boot image from. Accordingly, secondary source column 605 indicates that the secondary source for booting system 500A in accordance with the first, second, third, fourth, fifth, sixth, seventh, and eighth limited-pin boot modes respectively includes an external host device coupled to USB0, a host device coupled to UART0, an external host device coupled to UART0, an MMC device coupled to the second MMC interface, an external host device coupled to UART0, an external host device coupled to UART0, an MMC device coupled to the second MMC interface, and an MMC device coupled to the second MMC interface. Additionally, secondary source column 605 indicates that the secondary boot sources for booting system 500A in accordance with either the first or second NVP boot modes are configurable. As such, a user may define the secondary source for either the first or second programmable boot modes via an associated boot device.

It should be noted that boot mode table 600 is representative of an exemplary table and is not limited to what is illustrated. For example, each of the limited-pin configurations may correspond to different primary and secondary sources. Additionally, the associated system may support more than eight limited-pin boot modes, and more than two programmable boot modes.

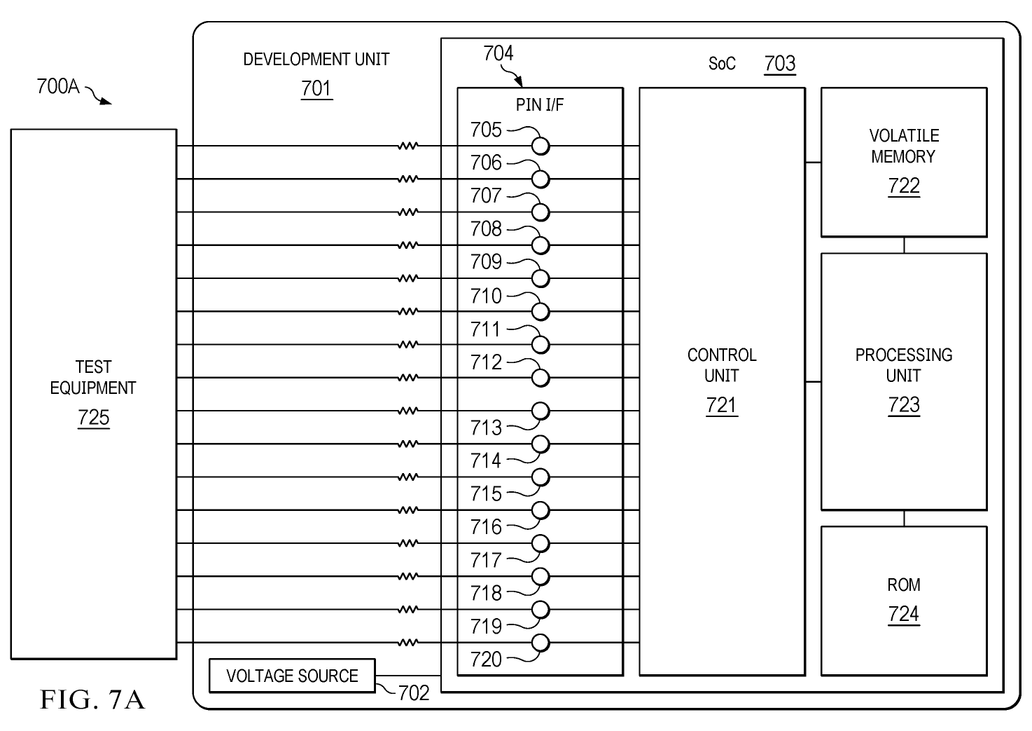

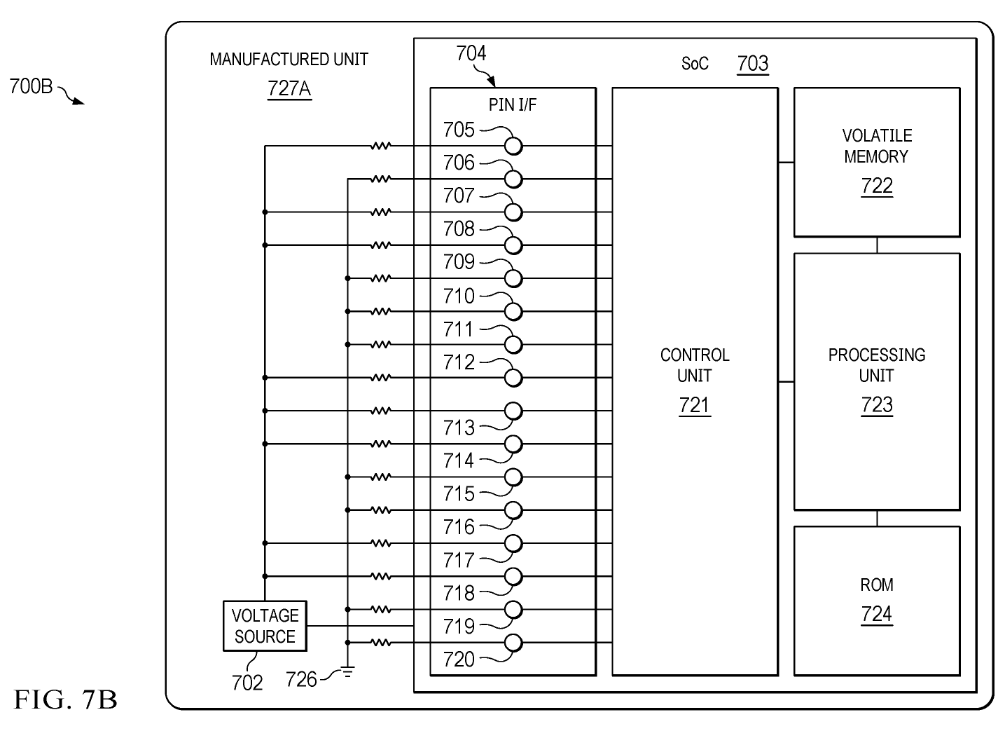

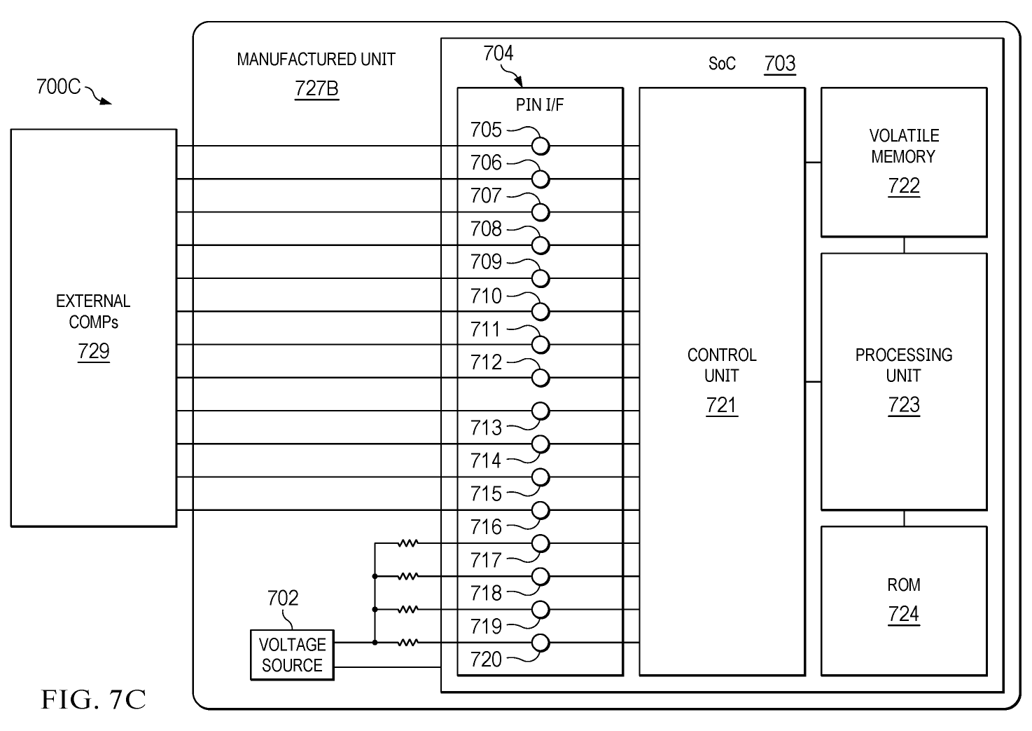

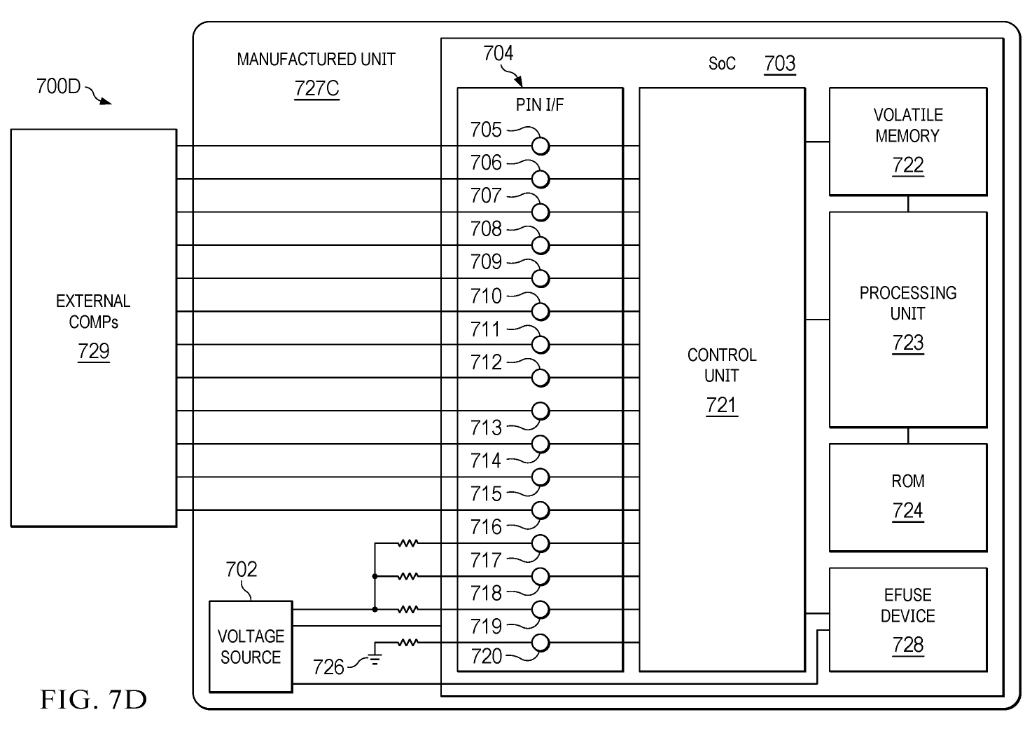

FIGS. 7A-7D illustrate a system that has been configured to boot in accordance with various pin configurations. More specifically, system 700A illustrates a development system that may be configured to boot in accordance with either a limited-pin or full-pin boot mode, system 700B illustrates a manufactured system that has been configured to boot in accordance with a full-pin boot mode, system 700C illustrates a manufactured system that has been configured to boot in accordance with a limited-pin boot mode, and system 700D illustrates a manufactured system that has been configured to boot in accordance with a programmable boot mode. Turning now to FIG. 7A, system 700A includes development unit 701 and test equipment 725.

Development unit 701 is representative of a device that supports limited-pin and full-pin configurations for initiating a boot process. Accordingly, development unit 701 depicts a device that provides flexibility to the user in choosing the desired boot mode. Development unit 701 includes, but is not limited to, voltage source 702 and SoC 703.

Voltage source 702 is representative of circuitry that powers development unit 701. For example, voltage source 702 depicts a battery, voltage regulator, power management integrated circuit (PMIC), DC-DC converter, or another source of the like that supplies voltages to the components of development unit 701. In an implementation, during system startup, voltage source 702 supplies a configuration signal to the boot pins of SoC 703, later discussed in detail with respect to FIGS. 7B-7D.

SoC 703 is representative of circuitry (e.g., device 101) that is capable of initiating a boot process. For example, SoC 703 may boot system 700A in accordance with a limited-pin boot mode of a limited-pin configuration or a full-pin boot mode of a full -pin configuration. SoC 703 includes, but is not limited to, pin interface 704, control unit 721, volatile memory 722, processing unit 723, and ROM 724.

Pin interface 704 is representative of circuitry that provides connection points to development unit 701. For example, pin interface 704 depicts pins 102 and 103 of FIG. 1 and pin interface 501 of FIG. 5A. In an implementation, pin interface 704 includes sixteen pins (i.e., pins 705-720) that may function as either device pins or boot pins. A device pin refers to a connection point that has been configured to interface with an external component, while a boot pin refers to a connection point that has been configured to receive a configuration signal. For example, if SoC 703 is configured to boot system 700A in accordance with a limited-pin configuration, then pins 705-716 function as device pins, while pins 717-720 function as boot pins during the boot process. Alternatively, if SoC 703 is configured to boot system 700A in accordance with a full-pin configuration, then pins 705-720 function as boot pins during the boot process. In an implementation, prior to configuring system 700A for a specific pin configuration and boot mode, a software developer determines if system 700A supports the limited-pin boot modes of the limited-pin configuration and the full-pin boot modes of the full-pin configuration. For example, the software developer may couple pins 705-720 to test equipment 725.

Test equipment 725 is representative of circuitry capable of generating configuration signals that correspond to both limited-pin and full-pin configurations. For example, test equipment 725 depicts a signal generator, MCU, or another development board of the like that is capable of applying controlled voltage levels to the boot pins of development unit 701. In an implementation, a software developer utilizes test equipment 725 to determine if development unit 701 supports all possible limited-pin and full-pin boot mode options. For example, the software developer may supply test equipment 725 with binary values that correspond to every possible limited-pin and full-pin boot mode option, and in response, test equipment 725 generates a configuration signal for each of the boot modes. Once generated, test equipment 725 supplies the configuration signals to control unit 721 via the boot pins of development unit 701. For example, to test the limited-pin boot modes, test equipment supplies 4-bit configuration signals to control unit 721. Meanwhile, to test full-pin boot modes, test equipment supplies 16-bit configuration signals to control unit 721.

Control unit 721 is representative of circuitry that generates a boot value for initializing system 700A. For example, control unit 721 depicts control circuitry 104 of FIG. 1 and mode control unit 518 of FIG. 5A. In an implementation, control unit 721 converts received configuration signals into 16-bit boot values that identify the boot mode for initializing system 700A. For example, if test equipment 725 outputs a configuration signal that corresponds to a 16-bit binary value to control unit 721, then control unit 721 converts the 16-bit configuration signal into a 16-bit boot value and stores the 16-bit boot value in a register of volatile memory 722. Alternatively, if test equipment 725 outputs a configuration signal that corresponds to a 4-bit binary value to control unit 721, then control unit 721 converts the 4-bit configuration signal into a 16-bit boot value and stores the 16-bit boot value in a register of volatile memory 722.

Volatile memory 722 is representative of a memory that stores instructions, data, and the like for development unit 701. For example, volatile memory 722 depicts volatile memory 107 of FIG. 1. In an implementation, volatile memory 722 includes a mode register (e.g., mode register 108) and an eFUSE register (not pictured). The mode register is representative of a register that stores the boot value generated by control unit 721. Meanwhile, the eFUSE register is representative of a register that stores an eFUSE boot value, later discussed in detail with reference to FIG. 7D. In an implementation, during system startup, processing unit 723 is triggered to read the boot value from the mode register to determine the primary and secondary boot sources for initializing system 700A.

Processing unit 723 is representative of circuitry that executes program code for initializing system 700A and subsequently operating system 700A after initialization. For example, processing unit 723 depicts processing circuitry 109 of FIG. 1. In an implementation, to boot system 700A, processing unit 723 executes the bootloader stored in ROM 724.

ROM 724 is representative of a non-volatile memory that stores instructions, data, and the like for SoC 703. For example, ROM 724 depicts ROM 110 of FIG. 1. In an implementation, ROM 724 stores a bootloader (e.g., bootloader 111) that, when executed by processing unit 723, causes processing unit 723 to boot system 700A. For example, when executed by processing unit 723, the bootloader causes processing unit 723 to read the boot value stored by the mode register, and possibly read the eFUSE boot value stored by the eFUSE register, to determine the primary and secondary boot sources for initializing system 700A. Once determined, bootloader 111 then causes processing circuitry 109 to transfer application-specific program code from either the primary or secondary boot source to volatile memory 107.

Now turning to FIG. 7B, system 700B depicts a version of system 700A that has been manufactured to boot in accordance with a full-pin boot mode. As such, system 700B includes manufactured unit 727A. Manufactured unit 727A is representative of a system that has been manufactured to boot in accordance with a specific full-pin boot mode. Accordingly, pins 705-720 are coupled to voltage source 702 and ground 726 in an arrangement that corresponds to the configuration signal for that specific full-pin boot mode (e.g., 0011_0011_1000_1101). More specifically, pins 705, 707, 708, 712, 713, 714, 717, and 718 are coupled to voltage source 702 via a corresponding resistor, while pins 706, 709, 710, 711, 715, 716, 719, and 720 are coupled to ground 726 via a corresponding resistor. It should be noted that, in other implementations, pins 705, 707, 708, 712, 713, 714, 717, and 718 may be coupled to voltage source 702 via a corresponding switch, while pins 706, 709, 710, 711, 715, 716, 719, and 720 are coupled to ground 726 via a corresponding switch. In such implementations, a user may test various limited-pin and full-pin boot modes by adjusting the switches.

When system 700B starts up, pins 705-720 are supplied with a 16-bit configuration signal and processing unit 723 begins executing the bootloader from ROM 724. Next, pins 705-720 route the 16-bit configuration signal to control unit 721, and in response, control unit 721 routes a 16-bit boot value to volatile memory 722 based on the 16-bit configuration signal. For example, control unit 721 routes the 16-bit boot value to the mode register of volatile memory 722, and in response, the bootloader of ROM 724 causes processing unit 723 to read the boot value from the mode register and determine the primary and secondary boot sources for initializing system 700B in accordance with the full-pin boot mode.

Now turning to FIG. 7C, system 700C depicts another version of system 700A that has instead been manufactured to boot in accordance with a specific limited-pin boot mode. As such, system 700C includes manufactured unit 727B and external components 729 (e.g., external components 526). Manufactured unit 727B is representative of a system that has been manufactured to boot in accordance with a specific limited-pin boot mode. Accordingly, manufactured unit 727B is representative of system that reduces the amount of power that is consumed during the boot process, reduces the system cost, and increases the amount of available board area. As such, pins 705-716 are coupled to external components 729, while pins 717-720 are coupled to voltage source 702 via a corresponding resistor. More specifically, pins 717-720 are coupled to voltage source 702 in an arrangement that corresponds to the configuration signal for that specific limited-pin boot mode (e.g., 1111). It should be noted that external components 729 may be external to or internal to manufactured unit 727.

When system 700C starts up, pins 717-720 are supplied with a 4-bit configuration signal and processing unit 723 begins executing the bootloader from ROM 724. Next, pins 717-720 route the 4-bit configuration signal to control unit 721, and in response, control unit 721 routes a 16-bit boot value to volatile memory 722 based on the 4-bit configuration signal. For example, control unit 721 routes the 16-bit boot value to the mode register of volatile memory 722, and in response, the bootloader of ROM 724 causes processing unit 723 to read the boot value from the mode register and determine the primary and secondary boot sources for initializing system 700C in accordance with the limited-pin boot mode.

Now turning to FIG. 7D, system 700D depicts another version of system 700A that has instead been manufactured to boot in accordance with a specific programmable boot mode. As such, system 700D includes manufactured unit 727C, eFUSE device 728, and external components 729. Manufactured unit 727C is representative of a system that has been manufactured to boot in accordance with a specific programmable boot mode, while eFUSE device 728 is representative of exemplary circuitry that provides the boot value for the specific programmable boot mode. For example, eFUSE device 728 depicts non-volatile programmable circuitry such as an eFUSE array, OTP memory block, configuration fuse bank, or security fuse module that stores the programmed boot value. Accordingly, pins 705-716 are coupled to external components 729, and pins 717-720 are coupled to voltage source 702 and ground 726 in an arrangement that corresponds to the configuration signal for that specific programmable boot mode (e.g., 0111). More specifically, pins 717, 718, and 719 are coupled to voltage source 702 via a corresponding resistor, while pin 720 is coupled to ground 726 via a corresponding resistor.

When system 700D starts up, pins 717-720 are supplied with a 4-bit configuration signal, eFUSE device 728 provides the boot value for the programmable boot mode to control unit 721, and processing unit 723 begins executing the bootloader from ROM 724. In an implementation, to provide the boot value for the programmable boot mode to control unit 721, eFUSE device 728 first generates a 25-bit value that includes a 16-bit programmable boot value and 9-bits related to error correction. eFUSE device 728 then supplies the 25-bit value to error correction circuitry (not shown) that determines the validity of the 16-bit programmable boot value. For example, the error correction circuitry employs single-error-correction, double-error-detection (SECDED) techniques for determining whether the programmable boot value is valid. If the error correction circuitry determines that the programmable boot value is not valid, then the error correction circuitry outputs a warning to processing unit 723. Alternatively, if the error correction circuitry determines that the programmable boot value is valid, then the error correction circuitry provides the programmable boot value to control unit 721.

Next, pins 717-720 route the 4-bit configuration signal to control unit 721, and in response, control unit 721 routes the provided 16-bit programmable boot value to the mode register of volatile memory 722. In response, the bootloader of ROM 724 causes processing unit 723 to read the programmable boot value from the mode register to determine the primary and secondary boot sources for initializing system 700D in accordance with the programmable boot mode.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Circuits described herein are reconfigurable to include additional or different components to provide functionality at least partially similar to functionality available prior to the component replacement.

Modifications are possible in the described embodiments, and other embodiments are possible, within the scope of the claims.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A device comprising:
control circuitry;
processing circuitry; and
a mode register coupled to the control circuitry and the processing circuitry;
wherein the control circuitry is configurable to:
receive a configuration signal on a set of pins;
determine, based on a first portion of the configuration signal received on a first subset of the pins, whether to boot the device according to a first pin configuration or a second pin configuration;
in response to determining to boot the device per the first pin configuration:
generate a boot value using the first portion of the configuration signal and a second portion of the configuration signal received on a second subset of the pins; and
store the boot value in the mode register;
in response to determining to boot the device per the second pin configuration:
generate the boot value using the first portion of the configuration signal, the second portion of the configuration signal, and a third portion of the configuration signal received on a third subset of the pins; and
store the boot value in the mode register; and
wherein the processing circuitry is configurable to:
read the boot value from the mode register;
identify one or more boot sources based on the boot value; and
boot the device from the one or more boot sources.

2. The device of claim 1, wherein the first subset of the pins comprises two pins, wherein the first portion of the configuration signal comprises two bits represented by a voltage signal on each of the two pins, and wherein the control circuitry determines to boot the device in the first pin configuration or the second pin configuration based on a combination of the two bits.

3. The device of claim 2, wherein the control circuitry determines to boot the device in the first pin configuration when the combination of the two bits includes a one, and wherein the control circuitry determines to boot the device in the second pin configuration when the combination of the two bits consists of zeros.

4. The device of claim 3, wherein:
the second subset of the pins comprises two additional pins;
the second portion of the configuration signal comprises two additional bits represented by a voltage signal on each of the two additional pins;
the third subset of the pins comprises twelve additional pins; and
the third portion of the configuration signal comprises twelve additional bits represented by a voltage signal on each of the twelve additional pins.

5. The device of claim 4, wherein the first pin configuration includes a set of limited-pin boot modes and wherein the control circuitry, when the combination of the two bits includes the one, generates the boot value based on the two bits and the two additional bits.

6. The device of claim 5, wherein the boot value includes a 16-bit value that identifies a limited-pin boot mode from the set of limited-pin boot modes when the combination of the two bits includes the one.

7. The device of claim 5, wherein the first pin configuration further includes a set of programmable boot modes and wherein the control circuitry, when the combination of the two bits includes the one, generates the boot value based at least on the two bits and the two additional bits.

8. The device of claim 7, wherein the boot value includes a 16-bit value that identifies a programmable boot mode from the set of programmable boot modes when the combination of the two bits includes the one.

9. The device of claim 4, wherein the second pin configuration includes a set of full-pin boot modes and wherein the control circuitry, when the combination of the two bits consists of the zeros, generates the boot value based on the two bits, the two additional bits, and the twelve additional bits.

10. The device of claim 9, wherein the boot value includes a 16-bit value that identifies a full-pin boot mode from the set of full-pin boot modes when the combination of the two bits consists of the zeros.

11. The device of claim 1, wherein the first subset of the pins, the second subset of the pins, and the third subset of the pins are coupled to test equipment.

12. The device of claim 1, wherein the first subset of the pins and the second subset of the pins are coupled to a voltage source or a ground and wherein the third subset of the pins is coupled to external components.

13. The device of claim 1, wherein the first subset of the pins and the second subset of the pins are coupled to a voltage source or a ground and wherein the third subset of the pins are coupled to an electronic fuse device.

14. Control circuitry comprising:
interface circuitry configurable to receive a configuration signal on a set of pins; and
logic circuitry configurable to:
determine, based on a first portion of the configuration signal received on a first subset of the pins, whether to boot a device according to a first pin configuration or a second pin configuration;
in response to determining to boot the device per the first pin configuration:
generate a boot value using the first portion of the configuration signal and a second portion of the configuration signal received on a second subset of the pins; and
store the boot value in a mode register;
in response to determining to boot the device per the second pin configuration:
generate the boot value using the first portion of the configuration signal, the second portion of the configuration signal, and a third portion of the configuration signal received on a third subset of the pins; and
store the boot value in the mode register.

15. The control circuitry of claim 14, wherein:
the first subset of the pins comprises two pins;
the first portion of the configuration signal comprises two bits represented by a voltage signal on each of the two pins,
the logic circuitry determines to boot the device in the first pin configuration when a combination of the two bits includes a one; and
the logic circuitry determines to boot the device in the second pin configuration when the combination of the two bits consists of zeros.

16. The control circuitry of claim 15, wherein:
the second subset of the pins comprises two additional pins;
the second portion of the configuration signal comprises two additional bits represented by a voltage signal on each of the two additional pins;
the third subset of the pins comprises twelve additional pins; and
the third portion of the configuration signal comprises twelve additional bits represented by a voltage signal on each of the twelve additional pins.

17. The control circuitry of claim 16, wherein:
the first pin configuration includes a set of limited-pin boot modes;
the logic circuitry, when the combination of the two bits includes the one, generates the boot value based on the two bits and the two additional bits; and
the boot value includes a 16-bit value that identifies a limited-pin boot mode from the set of limited-pin boot modes when the combination of the two bits includes the one.

18. The control circuitry of claim 16, wherein:
the second pin configuration includes a set of full-pin boot modes;
the logic circuitry, when the combination of the two bits consists of the zeros, generates the boot value based on the two bits, the two additional bits, and the twelve additional bits; and
the boot value includes a 16-bit value that identifies a full-pin boot mode from the set of full-pin boot modes when the combination of the two bits consists of the zeros.

19. A method comprising:
by interface circuitry:
receiving a configuration signal on a set of pins;
by logic circuitry:
determining, based on a first portion of the configuration signal received on a first subset of the pins, whether to boot a device according to a first pin configuration or a second pin configuration;
in response to determining to boot the device per the first pin configuration:
generating a boot value using the first portion of the configuration signal and a second portion of the configuration signal received on a second subset of the pins; and
storing the boot value in a mode register;
in response to determining to boot the device per the second pin configuration:
generating the boot value using the first portion of the configuration signal, the second portion of the configuration signal, and a third portion of the configuration signal received on a third subset of the pins; and
storing the boot value in the mode register.
by processing circuitry:
reading the boot value from the mode register;
identifying one or more boot sources based on the boot value; and
booting the device from the one or more boot sources.

20. The method of claim 19, wherein:
the first subset of the pins comprises two pins;
the first portion of the configuration signal comprises two bits represented by a voltage signal on each of the two pins;
the logic circuitry determines to boot the device in the first pin configuration when a combination of the two bits includes a one; and
the logic circuitry determines to boot the device in the second pin configuration when the combination of the two bits consists of zeros.
